(19) United States
(12) Patent Application Publication
(10) Pub. No.: US 2009/0138965 A1
(43) Pub. Date: May 28, 2009

(54) SYSTEMS AND METHODS FOR PROVIDING ACCESS CONTROL AND ACCOUNTING INFORMATION FOR WEB SERVICES

(75) Inventor: Andrew Rodney Ferlitsch, Camas, WA (US)

Correspondence Address: AUSTIN RAPP & HARDMAN, 170 SOUTH MAIN STREET, SUITE 735, SALT LAKE CITY, UT, 84101, US

(73) Assignee: Sharp Laboratories of America, Inc., Camas, WA (US)

(21) Appl. No.: 11/945,040

(22) Filed: Nov. 26, 2007

(51) Int. Cl. H04L 9/32

(52) U.S. Cl. 726/21

(57) ABSTRACT

A method for providing access control and accounting information for one or more services is described. A service request is received from a device. A service to execute the service request is selected. A determination is made whether the device is authorized to access the selected service. The accounting information associated with executing the service request using the selected service is calculated.

### TECHNICAL FIELD

The present invention relates generally to computers and computer-related technology. More specifically, the present invention relates to systems and methods for providing access control and accounting information for web services.

### BACKGROUND

Computer and communication technologies continue to advance at a rapid pace. Indeed, computer and communication technologies are involved in many aspects of a person's day. For example, many devices being used today by consumers have a small computer incorporated within the device. These small computers come in varying sizes and degrees of sophistication. These small computers may vary in sophistication from one microcontroller to a fully-functional complete computer system. For example, small computers may be a one-chip computer, such as a microcontroller, a one-board type of computer, such as a controller, a typical desktop computer, such as an IBM-PC compatible, etc.

Printers are used with computers to print various kinds of items including letters, documents, pictures, etc. Many different kinds of printers are commercially available. Ink jet printers and laser printers are fairly common among computer users. Ink jet printers propel droplets of ink directly onto the paper. Laser printers use a laser beam to print.

Printers are a type of imaging device. Imaging devices include, but are not limited to, physical printers, multi-functional peripherals, a printer pool, a printer cluster, a fax machine, a plotter, a scanner, a logical device, an electronic whiteboard, a tablet PC, a computer monitor, a file, etc.

Different kinds of computer software facilitate the use of imaging devices. The computer or computing device that will be used to print the materials typically has one or more pieces of software running on the computer that enable it to send the necessary information to the printer to enable printing of the materials. If the computer or computing device is on a computer network there may be one or more pieces of software running on one or more computers on the computer network that facilitate printing.

Device management applications may manage these devices. Services associated with the devices may enhance the functionality of these devices. The services may be used to provide accounting information relating to the cost for using these devices. However, these device management applications do not provide access control and accounting information for services that are external to these devices. As such, benefits may be realized by providing improved systems and methods for providing access control and accounting information for external services utilized by these devices.

### BRIEF DESCRIPTION OF THE DRAWINGS

FIG. 1 is a block diagram illustrating one example of a network in which the present systems and methods may be implemented;

FIG. 2 is a block diagram illustrating one example of a web service;

FIG. 3 is a flow diagram illustrating one example of a method for requesting an external web service;

FIG. 4 is a flow diagram illustrating one example of a method for providing access control and accounting information for an external web service;

FIG. 5 is a block diagram illustrating one example of initiating either a walkup imaging job or a remote imaging job;

FIG. 6 is a flow diagram illustrating one example of a method for authenticating a user that transmits a service request for an external service;

FIG. 7 is a flow diagram illustrating one example of a method for determining a total cost associated with an external web service;

FIG. 8 is a block diagram illustrating the major hardware components typically utilized with example herein; and

FIG. 9 is a network block diagram illustrating one possible environment in which the present systems and methods may be implemented.

### DETAILED DESCRIPTION

A method for providing access control and accounting information for one or more services is described. A service request is received from a device. A service to execute the service request is selected. A determination is made whether the device is authorized to access the selected service. The accounting information associated with executing the service request using the selected service is calculated.

The service request may be a request to translate the format of an imaging job. In one example, the service request is executed. An executed service request may be transmitted to the device. The accounting information associated with executing the service request may be transmitted to the device.

The format of the output of the imaging job may be translated. An intermediate format of the imaging job may be translated. The intermediate format may be the format of the imaging job after the imaging job is inputted and before the imaging job is outputted.

In one example, the service is a web service. The accounting information may include a cost that is based on the type of the selected service, the size of the input of the imaging job and the quality of the output of the imaging job.

A user may provide the imaging job directly to the device. A host computing device may provide the imaging job to the device. In one example, the host computing device is located remotely from the device.

The device may be a multi-functional peripheral (MFP). The accounting information may be calculated by the device. A determination is made whether a user of the device is authorized to access the selected service.

In one example, the service is a natural language translation service. In another example, the service is an optical character recognition (OCR) service. In addition, the service may be a bates stamping service. In an additional example, the service is a bar code reading and bar code writing service. In a further example, the service is an image enhancement service. The service may also be a format translation service.

A computer system that is configured to provide access control and accounting information for one or more services is also described. The computer system includes a processor and memory in electronic communication with the processor. Instructions are stored in the memory. The instructions being executable to receive a service request from a multi-functional peripheral (MFP) device. The instructions are also executable to select a service to execute the service request. The instructions are further executable to determine whether the MFP is authorized to access the selected service. The instructions are also executable to calculate the accounting information associated with executing the service request using the selected service.

A computer-readable medium comprising executable instructions is also described. A service request is received from a device. A service is selected to execute the service request. A determination is made whether the device is authorized to access the selected service. The accounting information associated with executing the service request is calculated using the selected service.

Products have been developed for dealers and administrators to authorize and charge (or debit) the use of a multi-functional peripheral (MFP). In addition, products are being developed to allow for direct application printing (DAP). DAP may imply the client that performs the printing does not have the necessary driver or application. As such, external translation services may be provided for DAP.

Current devices and products may also support charging (or debiting) the use of MFPs for walkup copy jobs of hard-copy scans that include an input format that is native to the MFP. These device and products also support charging for the execution of print jobs which utilize an application or drive on the client. Accordingly, it would be beneficial to enhance these authorization/charging systems and methods to include the use of external translators for DAP.

A current method for charging based on detailed characteristics of a print job, may be demonstrated for a host-based print job where a printer provides a management information base (MIB). The MIB includes detailed information on printer usage. When a print job is initiated, a printer spooler initially queries the printer for the printer's current usage totals, prior to the execution of the print job. Usage totals may be obtained for characteristic details of the print job, such as the number of sheets per paper size, the number of sheets of black and white (BW), the number of sheets of color, the number of duplex sheets, the number of sheets per page description language (PDL) (e.g., printer control language (PCL) and PostScript (PS)), etc.

Once the printer spooler has obtained the current total usage, the spooler despools the print job to the printer. Once despooled, the spooler monitors the printer and waits for the printer to complete the print job. For example, the spooler waits for the printer to return back to an idle state. After the printer has completed the print job, the spooler may query the printer again for the updated total usage. The spooler may subtract the updated totals of usage from the previously obtained current totals of usage to determine the usage for the print job. Implementing the current method described above, the spooler may obtain usage information on a more detailed level than simply obtaining usage information from a click count. As such, by having this level of detail, a system can charge differently, depending on paper size, duplex and BW vs. color.

The current method described above is limited in that it provides counts only for print jobs that are host-based and print jobs need to be serialized to the printer. The method also does not provide external services, such as a translator, and it does not provide authorization control.

Another current method for authorizing usage of a printer may be demonstrated by printers which control access to the various PDL interpreters. For example, in some printers, the use of the PS interpreter may be restricted. An administrator may restrict the use of the PS interpreter to jobs that originate from certain client computing devices (e.g., by an Internet Protocol (IP) address) or the PS interpreter may be restricted based on a user.

In the former case, when a PS job arrives at the printer, the printer checks for which IP address the job originated from. If the IP address is not within the authorized list, the job is rejected. In the later case, when the user generates a print job, the printer driver adds a “userID” to the job. The “userID” may be used by the user to login to a device, network, etc. The printer may then extract the “userID” from the job and compare it to the authorized list. If the “userID” is not within the authorized list, the job is rejected. However, this current method is limited in that it only covers authorization of users and does not provide a charging service to execute the print job. In the case of “userIDs”, the print job may be spoofed by adding a fake “userID” to the job. In other words, this method does not provide an actual network login authentication for the job. The method is also limited to print jobs and this method does not implement authorization or charging services when external services are utilized (e.g., format translation).

Some methods have implemented web service enabled MFPs. In a web service environment, multiple devices are interconnected through a network. These multiple devices advertise their respective services to each other. Additionally, each device supports authentication of both the device and a user requesting/using a service. Generally, a user would login to a device; whereby, the device authenticates the user via a network domain controller. The user requests some service that is available within the network. If some, or all, of the services are not available at the local device, the local device obtains the service via another device. Additionally, the request for the service includes the user's authentication; whereby, the user may be permitted or denied the use of the service. Current methods that implement web service enabled MFPs are still limited in that they do not implement external services for format translation and no accounting system is provided that relates to a charging service for the external format translation.

The present systems and methods provide an effective method for authorization and charging in a web services environment, for services that provide format translations for direct application printing (DAP). The format translators may translate the format of the input of a job and/or the output of the job. In addition, the DAP may be either a walkup print job or a remote print job.

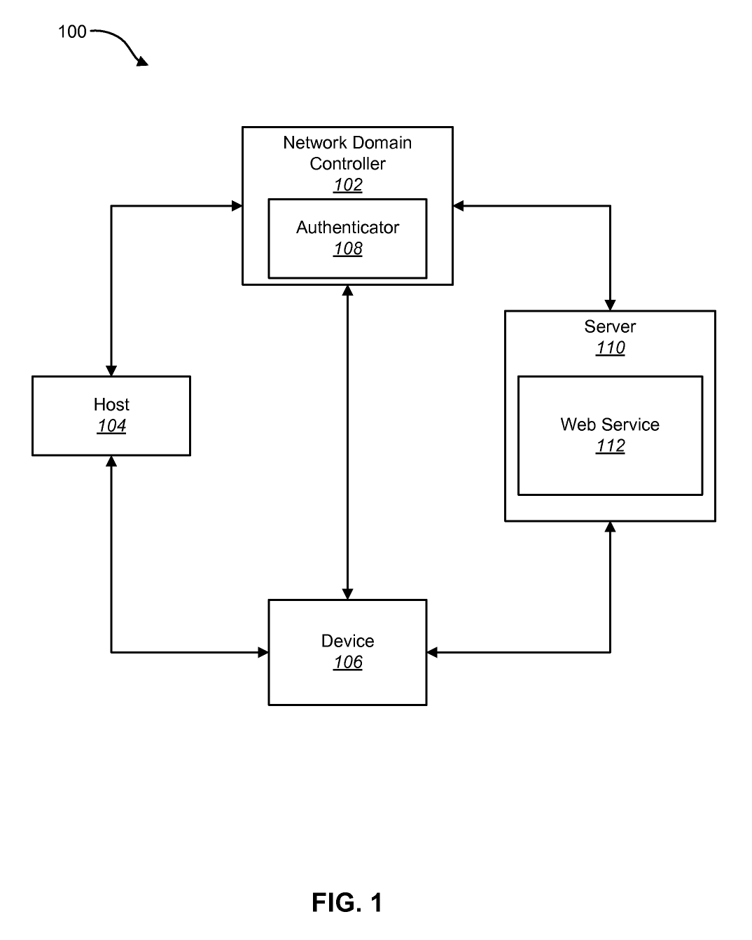

FIG. 1 is a block diagram illustrating one example of a network 100 in which the present systems and methods may be implemented. A device 106 may be in communication with a host computing device 104 and a server 110. Although a single device 106, a single host 104 and a single server 110 are illustrated, one or more of such devices (i.e., device 106, host 104 and server 110) may be present in the network 100. In one example, the device 106 is a MFP. The device 106 may provide one or more imaging capabilities, such as printing, copying, scanning, filing, faxing, conversion, publishing, displaying, etc.

The server 110 may include a web service 112. The server 110 may include more than one web service 112. Services that may be provided by the server 110 via the web service 112 may include format translation, natural language translation, optical character recognition (OCR), bates stamping, bar code reading/writing, storage, image enhancement, compression, encryption, watermarks, indexing, filing, etc. The device 106 may request the use of the web service 112 from the server 110. The host 104 may initiate rendering jobs with the device 106. In one example, the host 104 is in a remote location as compared to the location of the device 106. In another example, the server 110 is in a remote location as compared to the location of the device 106. When the server 110 is in a remote location or external to the device 106, communications between the server 110 and the device 106 may pass through a firewall (not shown).

The host 104, device 106 and server 110 may be interconnected in the network 100 with a network domain controller 102. The controller 102 may include an authenticator 108 which allows the host 104 and device 106 to be authenticated within the network domain. In addition, the authenticator 108 may authenticate services provided by the server 110, such as the web service 112. Further, the authenticator 108 may authenticate users of the host 104, device 106 and web service 112. The host 104, device 106, controller 102 and server 110 may be connected and communicate with each other by any means, such as through a wired network, a wireless network, Transmission Control Protocol (TCP)/Internet Protocol (IP), Hypertext Transfer Protocol (HTTP)/Hypertext Markup Language (HTML), Simple Object Access Protocol (SOAP)/Extensible Markup Language (XML), etc. The device 106 may also be a wireless mobile device and communicate using wireless protocols such as Bluetooth, WiFi and WiMAX. The device 106 may also communicate using data protocols such as Short Messaging Service (SMS)/Multi-Media Messaging Service (MMS).

A user may initiate either a walkup print job or a remote print job (i.e., from the host 104) to the device 106. The print job may include either a non-native input and/or a non-native output. The device 106, such as an MFP, utilizes an external service (e.g., the web service 112) to perform a translation of either the input or the output to the native format. To initiate the print job, the user may log into the network 100 where the user is authenticated by the authenticator 108. A user may log into the network 100 by other authentication implementations. For example, a user may use a universal Open ID (e.g., Demoxi OpenID), or a signed digital certificate, such as a certificate signed by Verisign. In the former case, the network domain controller 102 validates the user's ID through an external trusted network domain controller. In the later case, the network domain controller 102 validates the user's digital certificate against a trusted store.

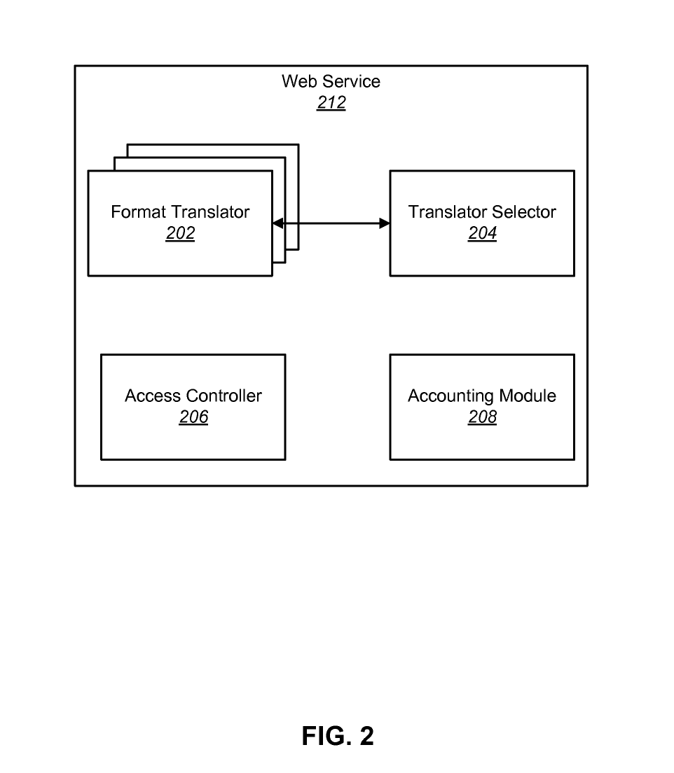

FIG. 2 is a block diagram illustrating one example of a web service 212. The service 212 may include a plurality of format translators 202. The translators 202 may translate the input of a print job from a non-native format to a native format. In addition, the format translators 202 may translate the output of a print job from a native format to a non-native format. A translator selector 204 may select one of the plurality of format translators 202 based on the input/output format of the print job. An access controller 206 may determine if either an authenticated user or device is authorized to use the selected format translator 202. An accounting module 208 may determine the costs associated with using the selected format translator 202. The accounting module 208 may provide this charge to the user. The accounting charge for the selected translator 202 may be a combination of factors, including the cost associated with the selected format translator 202 (e.g., license use), the cost associated with the size of the data to be translated (e.g., byte size, number of pages, etc.) and the cost associated with the output quality (e.g., color, resolution, image enhancement, etc.) Costs may also include local and state taxes, when the service 212 is a public service.

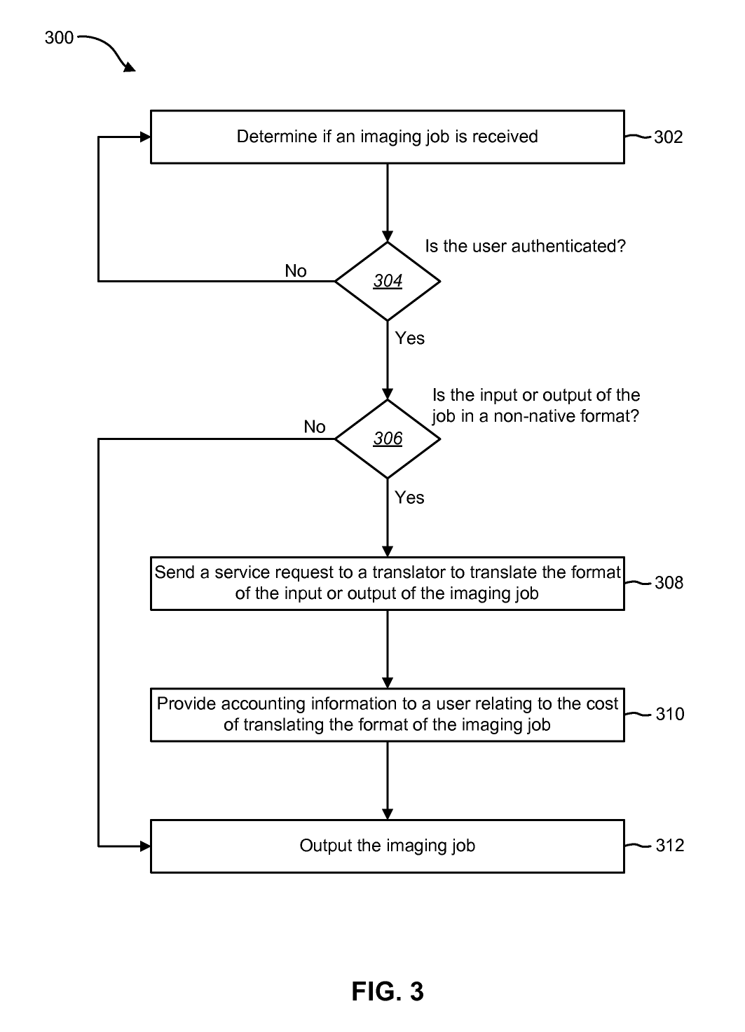

FIG. 3 is a flow diagram illustrating one example of a method 300 for requesting an external web service for a job, such as a print job, imaging job, etc. The method 300 may be implemented by the device 106, such as an MFP. In one example, the device determines 302 if an imaging job is received. Once an the imaging job has been received, a determination 304 is made as to whether the user that initiated the imaging job is authenticated. If the user is not authenticated, the device 106 returns to determine 302 when another imaging job is received. However, if it is determined 304 that the user is authenticated, a determination 306 is made as to whether the input and/or output of the imaging job are in a non-native format. If the input and/or output are not in a non-native format to the device 106, the imaging job is executed and outputted 312.

If it is determined 306 that the input and/or output are in a non-native format, a service request may be sent 308 to a translator. The translator may be an external service that translates the format of the input and/or output of the imaging job. Accounting information relating to the cost of translating the format of the imaging job may also be provided 310 to the user. The translated imaging job may be executed and outputted 312 to the user.

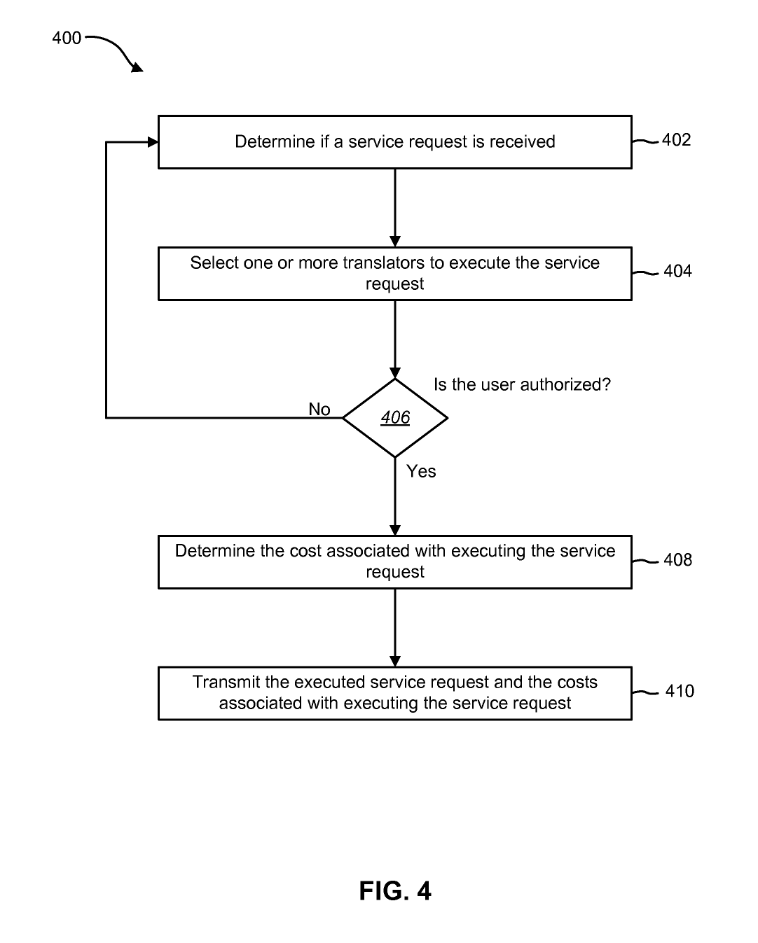

FIG. 4 is a flow diagram illustrating one example of a method 400 for providing access control and accounting information for a web service. The method 400 may be implemented by the web service 112. In one example, the web service determines 402 if a service request is received. The service request may be a request for translating the format of an imaging job, print job, etc. One or more translators may be selected 404 to execute the service request. A determination 406 may be made as to whether the user is authorized to use the selected translator. If the user is not authorized, the web service continues to determine 402 if a service request is received. If the user is authenticated to use the selected service, the cost associated with executing the service request using the selected translator is determined 408. The executed service request and the costs associated with executing the service request may be transmitted 410 to the user.

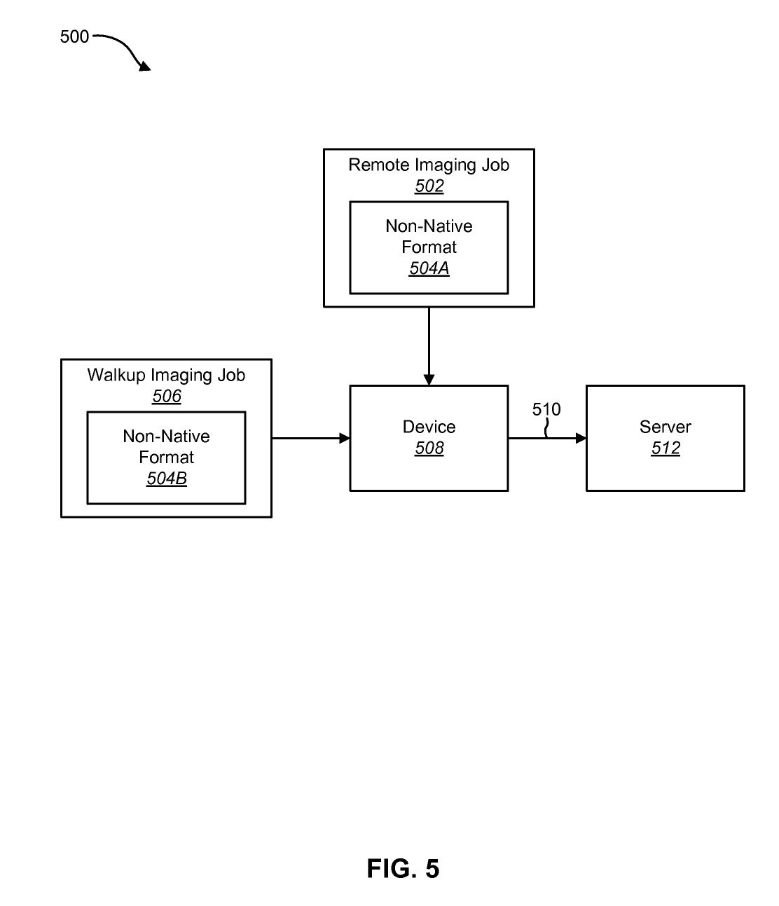

FIG. 5 is a block diagram 500 illustrating one example of initiating either a walkup imaging job 506 or a remote imaging job 502. A user may initiate an imaging job as either the walkup job 506 (i.e., initiated at a device 508) or a host-based remote job 502 (i.e., initiated at a host-computing device 104). As part of the initiation, the user may log into either the device 508 or the host 104, whereby the user may be authenticated within a network domain by a network domain controller 102.

In one example, the user initiates an imaging job where the input is a softcopy and the output is a hardcopy. In other examples, the imaging operation may include a hardcopy input (e.g., a scan), or a softcopy output (e.g., a fax) or both input an output as a hardcopy (e.g., a copy) or softcopy (e.g., a file). At least one input, output or intermediate step is in a softcopy format.

The softcopy format may be a non-native format 504A, 504B to the device 508. In the case of the input of an imaging job 502, 506, the device 508 may not have a resident interpreter for the format of the input. In the case of the output of the job 502, 506, the device 508 may not have a resident output generator for the format of the output.

When the device 508 detects an input or output that is non-native, the device 508 may locate an external service that can perform a format translation. The service may be located on a server 512. The device 508 may send a service request 510 to the server 512 for the service. If the request is to translate the input, the format of the input is translated from a non-native format to a native format. If the request is to translate the output, the format of the output is translated from a native format to a non-native format.

The device 508 may locate the external translation service by any means, such as an administrator predefining the location in the device 508. For example, the location may be entered via front or remote interfaces or loaded using a service profile. In addition, the location may be dynamically entered by the user, as part of initiating the imaging job. The location may be registered in the device 508 by the service. The service may statically register itself with the device 508. The service may also dynamically register itself with the device 508, such as by broadcasting or multicasting (e.g., WS-Discovery) its service availability. The location may also be dynamically discovered by the device 508. The device 508 may discover the service by broadcasting or multicasting (e.g., WS-Discovery) the request 510. The device 508 may also discover the service by polling (e.g., Simple Network Management Protocol (SNMP) sweep) or otherwise enumerating through a list of predefined communication addresses.

In addition, the service request 510 may include information about the user. This information may be used to authenticate the user. The transmission of the request 510 may also be secured or unsecured. Examples of methods for transmitting the service request 510 include SOAP, XML, TCP/IP, AppleTalk, HTTP/HTML, etc.

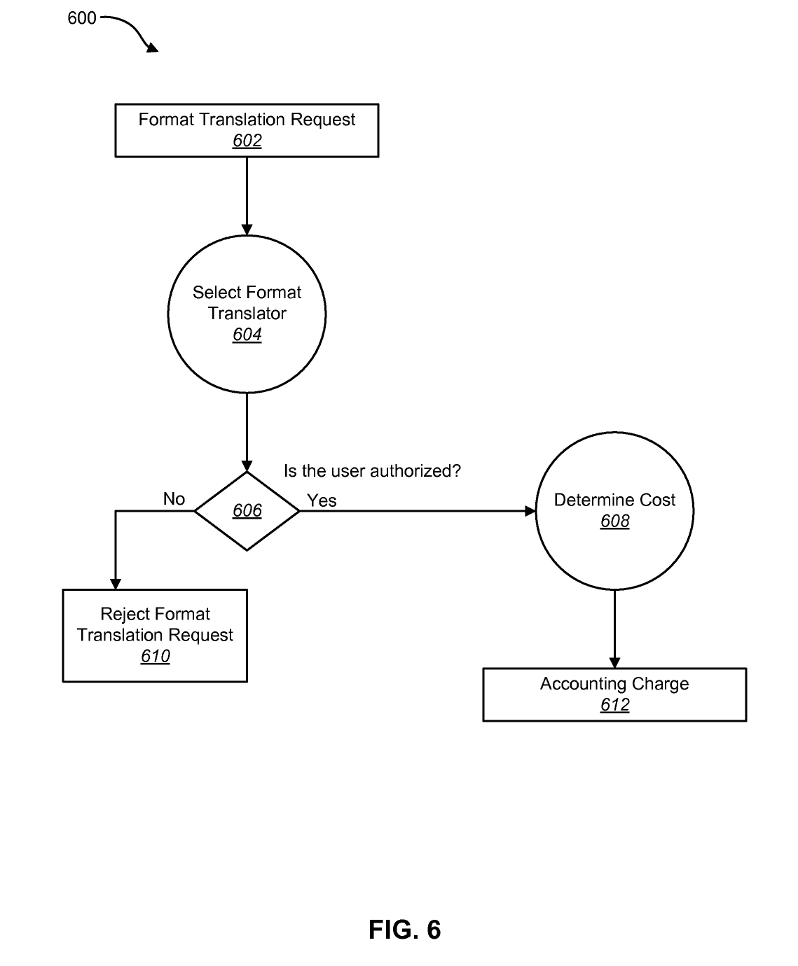

FIG. 6 is a flow diagram illustrating one example of a method 600 for authenticating a user that transmits a service request for an external service. In one example, when an external translation service receives a service request, an authentication and charging process may be executed. The service request may be a format translation request 602.

The external translation service may determine or select 604 which format translator(s) are needed for the request 602. A determination 606 is made as to whether the authenticated user or device is authorized to use the format translator. The authentication of the user may be part of the communication protocol or auxiliary information embedded in the request 602 (e.g., metadata including the user's network login name) or derived from the communication request (e.g., IP address or digital signature of originating source).

An administrative control may be used to set which users and devices may use certain format translation services. If the user or device is not authorized to use the required translation services, the request is rejected 610.

Additionally, quotas may be set on the use of the service. In some examples where a format translation service is not authorized for use, or the quota is used up, another compatible format translation service which is authorized may be utilized. For example, a format translation service provided by another external service, a lower quality format translation service, a slower format translation service, etc.

If the user and/or device are authorized to use the selected translator, a cost for the translation service is determined 608. The calculation of the cost may be determined before or after initiation of the translation service. In other examples, the cost may be estimated before the translation and verified afterwards. If the cost is determined beforehand, the cost information may be used in a debit charging system or in a post charge accounting system. In the debit system, the calculated/estimated charge may be compared to existing sums or quotas remaining for the user and/or device. If the amount is deficient, the charging method may cancel the operation or request the user to add additional funds. When the charging system cancels or requests additional funds, the system may send a message to the device and user indicating so by any means, such as sending a message (e.g. web service) which is displayed on the front panel of the device 106 or at the host computing device 104, or sending an email.

In a charging system, the charge may be added to a user's account after completion of a job. The accounting system may be located anywhere, such as the same host computing device as the external service (e.g., the server 110), on a separate computing device from the external service, within the device 106 performing the imaging job, etc. An accounting charge 612 associated with the service may be provided.

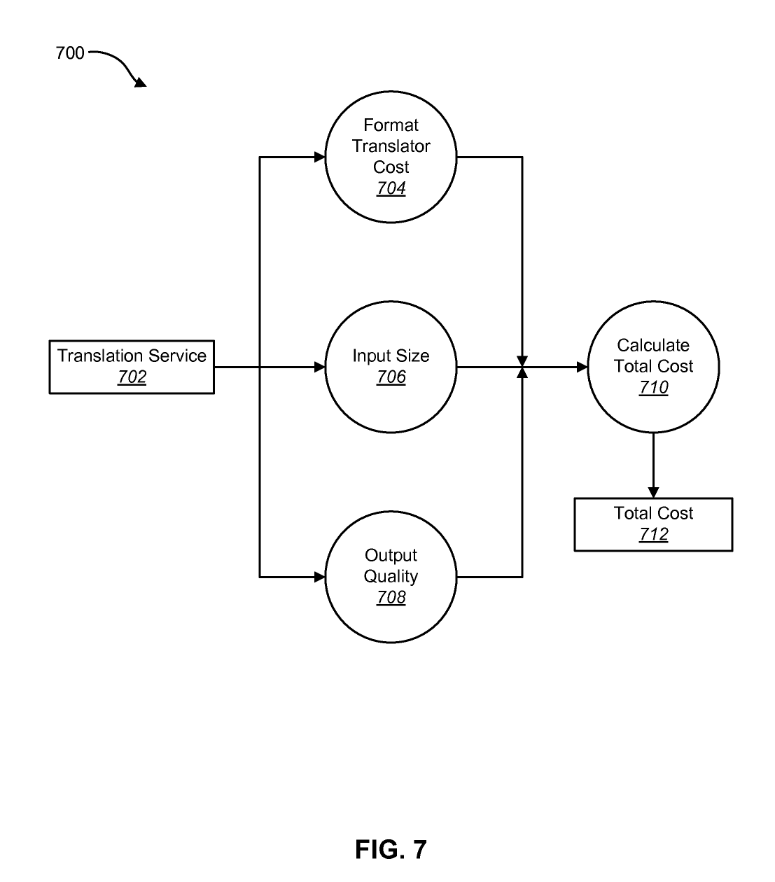

FIG. 7 is a flow diagram illustrating one example of a method 700 for determining a total cost 712 associated with an external service, such as a translation service 702. The total cost 712 of the format translation service 702 may be based on a combination of factors. In one example, the factors are a format translator cost 704, an input size 706 and an output quality 708. In other examples, other factors may be considered.

The cost of using a particular format translator 704 may be based on any factor, such as a fixed per use cost based on a license fee or a capped fixed cost. In one implementation the total cost 712 may not exceed a capped amount. In other configurations, the cost may depend on a time of day, region or locale. In yet other configurations, the cost may include local and state taxes.

A second cost may be derived from the size of the input 706 to translate. The input size 706 may be calculated by any means, such as byte size of the data to translate, the number of pages in a document or images in an image file, the complexity of the input, etc. When the input size cost 706 is pre-calculated, the method 700 may obtain information on the input size by any means, such as transmitting the data of the file to be translated to the external service or transmitting the size information to the external service.

A third cost may be derived from the output quality 708. The output quality may be calculated by any means, such as the output format, the output resolution, color, image enhancements, etc.

The costs of each of these factors may be combined and the total cost 712 may be calculated 710. In some examples, the user may be pre-informed of the total cost 712 prior to initiating the translation. If the total cost 712 exceeds some maximum cost, the user may choose to modify some aspect of the translation to reduce the total cost 712, such as lower the output quality, select a different format translator, limit the amount of data to translate, etc.

A job accounting function for the translation services described above may be integrated with a job accounting system by any means. In one example, the job accounting system is implemented (wholly included) within the device 106. The device 106 includes a job and accounting record for each outputted job. In the case of a hard-copy output, the device 106 may monitor the number of sheets outputted, and certain characteristics of the sheets: size, duplex print, finishing, color vs. BW. The job accounting function may charge on a sheet basis, where the charge per sheet is based on the certain characteristics of each sheet.

In this example, the final accounting record may also include the translation service costs. The device 106 may assign internal unique job identification (ID) to the job, which it stores with the accounting record. The unique job ID may be sent with the translation job to the translation service. When the translation service completes the job and sends back the translated data, it also sends the translation costs and associated job ID. The job ID may be used by the MFP to add the translation costs to the job accounting record for the job. The translation costs may be added directly into the total costs, or maintained separately.

In a debit system, the translation service may send the predicted translation costs to the device 106 along with the job ID. The system may compare the predicted translation costs (and any other predicted cost) to the user's account balance. If the account balance is insufficient, the user may be prompted to input more funds, such as through a coin-op device or credit-card reader.

In another example, the job accounting system is implemented via a job accounting server, which is separate from the device 106 and translation service. In one case, the job accounting service intercepts the print job before it arrives at the device 106. The interceptor parses the data to determine what resources (e.g., paper) would be consumed, and charges accordingly. Such a system may also query or receive events from the device 106 verifying that the job successfully outputted.

When the interceptor calculates the charges, it may also uniquely identify the job. The job name and job owner may be extracted from the document job. The job name/owner, along with the charge, may be sent to the accounting system.

Since the translation system may be independent of the interceptor, it too may extract the same unique identification information as the interceptor. When the translation system sends the translation charges to the accounting system, it also sends the associated unique identification information (e.g., job owner/name). In the above case, the accounting system may take multiple independent charges for the same document job. In other cases, the accounting system may prohibit this. In this case, the accounting system alters the job owner/name, so that it would appear to be unique to the accounting system. The alteration may be reversible, such that a second accounting process can locate both the document outputting charge and translation charge and combine them together.

In another example, accounting may be done on a periodic (e.g., monthly) usage basis, such as in a dealer equipment lease. In one example, each machine is programmed to send a total usage record (e.g., Sharp Email-RIC) at the end of each periodic period. In addition to including the total charges, the record uniquely identifies the device 106.

The translation service may also be programmed to send (when not directly integrated with the device 106), the total charges on the same periodic schedule. The translation service may also partition the accounting data across each device 106, such that the totals are reported on a device by device basis in the same way as reported by the device 106. As provided above, other examples include imaging operations other than a print job. Also, the data to translate may be an output or an intermediate format, in addition to an input format.

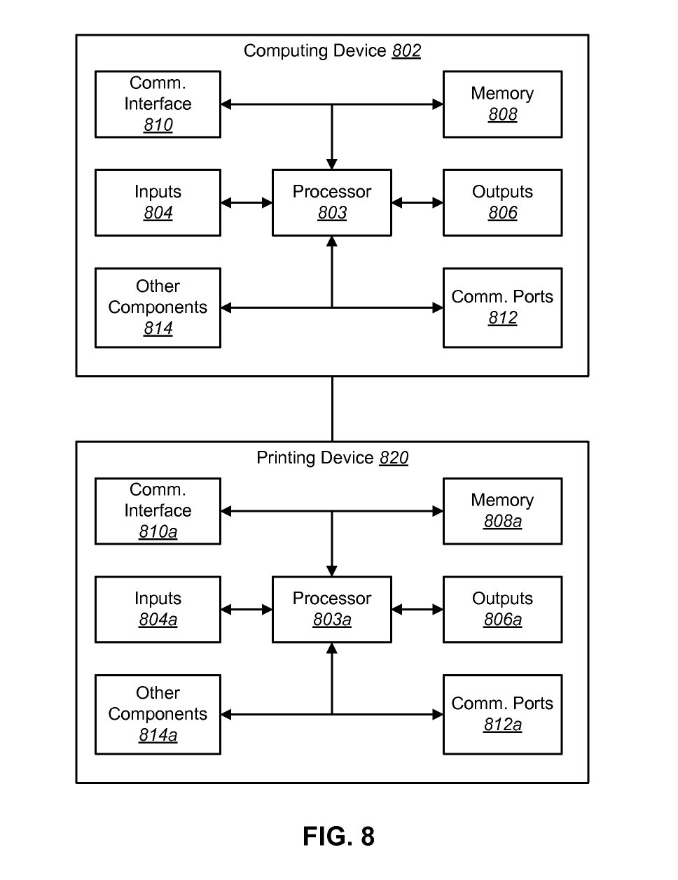

FIG. 8 is a block diagram illustrating the major hardware components typically utilized with examples herein. The systems and methods disclosed may be used with a computing device 802 and a printing device 820. The major hardware components typically utilized in a computing device 802 are illustrated in FIG. 8. A computing device 802 typically includes a processor 803 in electronic communication with input components or devices 804 and/or output components or devices 806. The processor 803 is operably connected to input 804 and/or output devices 806 capable of electronic communication with the processor 803, or, in other words, to devices capable of input and/or output in the form of an electrical signal. Examples of devices 802 may include the inputs 804, outputs 806 and the processor 803 within the same physical structure or in separate housings or structures.

The computing device 802 may also include memory 808. The memory 808 may be a separate component from the processor 803, or it may be on-board memory 808 included in the same part as the processor 803. For example, microcontrollers often include a certain amount of on-board memory.

The processor 803 is also in electronic communication with a communication interface 810. The communication interface 810 may be used for communications with other devices 802, printing devices 820, servers, etc. Thus, the communication interfaces 810 of the various devices 802 may be designed to communicate with each other to send signals or messages between the computing devices 802.

The computing device 802 may also include other communication ports 812. In addition, other components 814 may also be included in the computing device 802.

Many kinds of different devices may be used with examples herein. The computing device 802 may be a one-chip computer, such as a microcontroller, a one-board type of computer, such as a controller, a typical desktop computer, such as an IBM-PC compatible, a Personal Digital Assistant (PDA), a Unix-based workstation, etc. Accordingly, the block diagram of FIG. 8 is only meant to illustrate typical components of a computing device 802 and is not meant to limit the scope of examples disclosed herein.

The computing device 802 is in electronic communication with the printing device 820. A printing device 820 is a device that receives or transmits an imaging job, such as a Multi-Function Peripheral (“MFP”) or computing device. Printing devices include, but are not limited to, physical printers, multi-functional peripherals, a printer pool, a printer cluster, a fax machine, a plotter, a scanner, a copier, a logical device, a computer monitor, a file, an electronic whiteboard, a document server, a filing device, display device, audio/visual recorder/player, a media duplication device, etc. A typical printing device, such as a physical printer, fax machine, scanner, multi-functional peripheral or copier is a type of computing device. As a result, it also includes a processor, memory, communications interface, etc., as shown and illustrated in relation to FIG. 8. The printing device may be a single or a plural grouping (e.g., pool or cluster) of two or more devices.

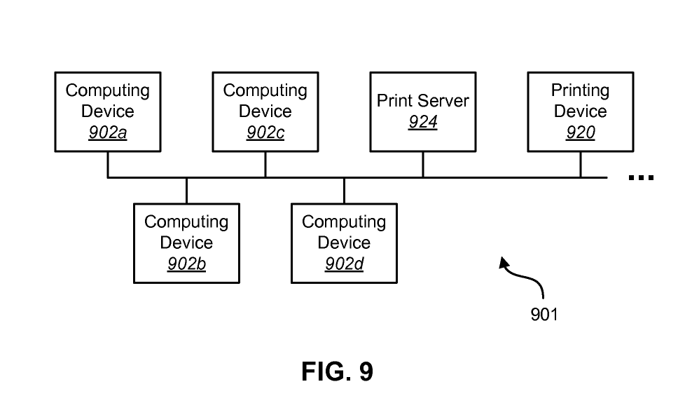

FIG. 9 is a network block diagram illustrating one possible environment in which the present systems and methods may be implemented. The present systems and methods may also be implemented on a standalone computer system. FIG. 9 illustrates a computer network 901 comprising a plurality of computing devices 902, a printing device 920 and a print server 924.

As used herein, the term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The various illustrative logical blocks, modules and circuits described in connection with the examples disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described in connection with the examples disclosed herein may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM and so forth. A software module may comprise a single instruction, or many instructions, and may be distributed over several different code segments, among different programs and across multiple storage media. An exemplary storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is required for proper operation of the example that is being described, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Functions such as executing, processing, performing, running, determining, notifying, sending, receiving, storing, requesting, and/or other functions may include performing the function using a web service. Web services may include software systems designed to support interoperable machine-to-machine interaction over a computer network, such as the Internet. Web services may include various protocols and standards that may be used to exchange data between applications or systems. For example, the web services may include messaging specifications, security specifications, reliable messaging specifications, transaction specifications, metadata specifications, XML specifications, management specifications, and/or business process specifications. Commonly used specifications like SOAP, WSDL, XML, and/or other specifications may be used.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for providing access control and accounting information for one or more services, comprising:
receiving a service request from a device;
selecting a service to execute the service request;
determining whether the device is authorized to access the selected service; and
calculating the accounting information associated with executing the service request using the selected service.

2. The method of claim 1, wherein the service request is a request to translate the format of an imaging job.

3. The method of claim 2, further comprising:
executing the service request;
transmitting an executed service request to the device; and
transmitting the accounting information associated with executing the service request to the device.

4. The method of claim 2, wherein the format of the output of the imaging job is translated.

5. The method of claim 2, wherein an intermediate format of the imaging job is translated, wherein the intermediate format is the format of the imaging job after the imaging job is inputted and before the imaging job is outputted.

6. The method of claim 1, wherein the service is a web service.

7. The method of claim 2, wherein the accounting information comprises a cost and is based on the type of the selected service, the size of the input of the imaging job and the quality of the output of the imaging job.

8. The method of claim 2, wherein a user provides the imaging job directly to the device.

9. The method of claim 2, wherein a host computing device provides the imaging job to the device, wherein the host computing device is located remotely from the device.

10. The method of claim 1, wherein the device is a multi-functional peripheral (MFP).

11. The method of claim 1, wherein the accounting information is calculated by the device.

12. The method of claim 1, further comprising determining whether a user of the device is authorized to access the selected service.

13. The method of claim 1, wherein the service is a natural language translation service.

14. The method of claim 1, wherein the service is an optical character recognition (OCR) service.

15. The method of claim 1, wherein the service is a bates stamping service.

16. The method of claim 1, wherein the service is a bar code reading and bar code writing service.

17. The method of claim 1, wherein the service is an image enhancement service.

18. A computer system that is configured to provide access control and accounting information for one or more services, the computer system comprising:
a processor;
memory in electronic communication with the processor;
instructions stored in the memory, the instructions being executable to:
receive a service request from a multi-functional peripheral (MFP) device;
select a service to execute the service request;
determine whether the MFP is authorized to access the selected service; and
calculate the accounting information associated with executing the service request using the selected service.

19. The computer system of claim 18, wherein the service request is a request to translate the format of an imaging job.

20. The computer system of claim 19, wherein the instructions are further executable to:
execute the service request;
transmit an executed service request to the MFP device; and
transmit the accounting information associated with executing the service request to the MFP device.

21. The computer system of claim 19, wherein the format of the output of the imaging job is translated.

22. The computer system of claim 19, wherein a user provides the imaging job directly to the MFP.

23. The computer system of claim 19, wherein a host computing device provides the imaging job to the MFP, wherein the host computing device is located remotely from the MFP.

24. The computer system of claim 18, wherein the instructions are further executable to determine whether a user of the MFP is authorized to access the selected service.

25. A computer-readable medium comprising executable instructions for:
receiving a service request from a device;
selecting a service to execute the service request;
determining whether the device is authorized to access the selected service; and
calculating the accounting information associated with executing the service request using the selected service.
